(19) United States
(12) Patent Application Publication
(10) Pub. No.: US 2024/0351921 A1
(43) Pub. Date: Oct. 24, 2024

(54) METHOD FOR PREVENTING AND TREATING POLLUTION PLUME MIGRATION OF PERMEABLE REACTIVE BARRIER

(71) Applicant: BCEG ENVIRONMENT REMEDIATION CO., LTD, Beijing (CN)

(72) Inventors: Lili GUO, Beijing (CN); Shupeng LI, Beijing (CN); Jiachen LI, Beijing (CN); Yaru LIU, Beijing (CN); Jiaming ZHANG, Beijing (CN); Shaoguo KANG, Beijing (CN); Hongwei XU, Beijing (CN); Jing XIONG, Beijing (CN); Qi WANG, Beijing (CN)

(73) Assignee: BCEG ENVIRONMENT REMEDIATION CO., LTD, Beijing (CN)

(21) Appl. No.: 18/759,087

(22) Filed: Jun. 28, 2024

Related U.S. Application Data
(63) Continuation-in-part of application No. PCT/CN2021/142739, filed on Dec. 29, 2021.

(51) Int. Cl. C02F 3/00; C02F 101/22; C02F 103/06

(52) U.S. Cl. CPC C02F 3/006; C02F 2101/22; C02F 2103/06; C02F 2209/04; C02F 2209/06; C02F 2209/08; C02F 2209/28; C02F 2209/30; C02F 2303/14

(57) ABSTRACT

A method for preventing and treating pollution plume migration of a permeable reactive barrier including: mounting monitoring assemblies, so as to monitor operation parameters of an active filler in a reactive barrier and a downstream water body of the reactive barrier in real time; determining whether the active filler in the reactive barrier is passivated according to a change state of the operation parameters, and if passivation occurs, performing a depassivation treatment on the reactive barrier; determining whether a gas blockage occurs in the active filler in the reactive barrier according to the change state of the operation parameters, and if a gas blockage occurs, performing a gas guiding treatment on the reactive barrier; and determining whether a microorganism content in the reactive barrier is greater than a preset microorganism value according to the change state of the operation parameters.

### CROSS-REFERENCE TO RELATED APPLICATIONS

The disclosure is the continuation-in-part application of the International Application PCT/CN2021/142739, entitled as “METHOD FOR PREVENTING AND TREATING POLLUTION PLUME MIGRATION OF PERMEABLE REACTIVE BARRIER” and filed on Dec. 29, 2021, which is incorporated in its entirety herein by reference.

### TECHNICAL FIELD

The disclosure relates to the technical field of pollution control of soil and underground water, and particularly relates to a method for preventing and treating pollution plume migration of a permeable reactive barrier.

### BACKGROUND

A permeable reactive barrier technology is to form a passive reaction zone by mounting a barrier filled with an active filler underground in a polluted site, so as to intercept or remove pollutants in underground water. In the prior art, when a reactive barrier is constructed through biogum filling, biogum used in construction can remain in the constructed barrier, which causes decrease of an overall permeability coefficient. Therefore, it is necessary to monitor and determine whether to further remove the biogum. As operation time of the reactive barrier continuously increases, interception and control abilities of the reactive barrier to pollutants can be greatly reduced, which will eventually fail.

### SUMMARY OF THE INVENTION

Therefore, in order to solve a technical problem that with increase of operation time, a pollution control ability of a permeable reactive barrier in the prior art obviously declines and even fails, the disclosure provides a method for preventing and treating pollution plume migration of a permeable reactive barrier.

In order to solve the above technical problem, the disclosure provides a method for preventing and treating pollution plume migration of a permeable reactive barrier. The method includes the following steps:

mounting monitoring assemblies in a reactive barrier and downstream of the reactive barrier, so as to monitor operation parameters of an active filler in the reactive barrier and a downstream water body of the reactive barrier in real time;

determining whether the active filler in the reactive barrier is passivated according to a change state of the operation parameters, and if passivation occurs, performing a depassivation treatment on the reactive barrier;

determining whether a gas blockage occurs in the active filler in the reactive barrier according to the change state of the operation parameters, and if a gas blockage occurs, performing a gas guiding treatment on the reactive barrier; and

determining whether a microorganism content in the reactive barrier is greater than a preset microorganism value according to the change state of the operation parameters, and if so, performing a bacteriostasis treatment on the reactive barrier.

Optionally, the operation parameters are one or more of a hexavalent chromium concentration, a pH value, a temperature, an underground water level and flow rate, a redox potential, a resistivity, a biological oxygen demand, a chemical oxygen demand, a product gas content, and a permeability coefficient.

Optionally, the product gas content is a nitrogen content and/or a methane content and/or a hydrogen content.

Optionally, the method further includes: injecting, if the permeability coefficient of the reactive barrier is smaller than a preset permeability range, biological enzymes into the reaction barrier after construction of the reactive barrier is completed.

Optionally, the method further includes: determining, if the permeability coefficient of the reactive barrier is greater than a preset permeability range and the hexavalent chromium concentration is greater than a preset concentration range, that the reactive barrier at a corresponding detection position is defective and repairing a defective part after construction of the reactive barrier is completed.

Optionally, during the operation of the reactive barrier, if the redox potential in the reactive barrier exceeds a preset potential range and the hexavalent chromium concentration downstream of the reactive barrier rises to exceed a preset concentration range, it is determined that the active filler in the reactive barrier is passivated.

When it is determined that the active filler in the reactive barrier is passivated, a filler cleaning agent is injected into the reactive barrier until the redox potential is changed to a preset range and the hexavalent chromium concentration downstream of the reactive barrier is changed to the preset concentration range, such that the depassivation treatment is completed.

Optionally, during the operation of the reactive barrier, if the hexavalent chromium concentration downstream of the reactive barrier rises to exceed a preset concentration range and the product gas content, the permeability coefficient and the pH value in the reactive barrier are unchanged, decreased and increased, respectively, it is determined that the active filler in the reactive barrier is passivated.

When it is determined that the active filler in the reactive barrier is passivated, a filler cleaning agent is injected into the reactive barrier until the hexavalent chromium concentration downstream of the reactive barrier is changed to the preset concentration range, such that the depassivation treatment is completed.

Optionally, during the operation of the reactive barrier, if the hexavalent chromium concentration downstream of the reactive barrier rises to exceed a preset concentration range and the product gas content and the permeability coefficient in the reactive barrier are increased and decreased, respectively, it is determined that a gas blockage occurs in the active filler; and

When it is determined that a gas blockage occurs in the active filler, extraction and gas guiding are performed on the reactive barrier until the hexavalent chromium concentration downstream of the reactive barrier is changed to the preset concentration range and the product gas content and the permeability coefficient in the reactive barrier are decreased and restored to a preset permeability range, respectively, such that the gas guiding treatment is completed.

Optionally, during the operation of the reactive barrier, if the hexavalent chromium concentration downstream of the reactive barrier rises to exceed a preset concentration range and the biological oxygen demand, the chemical oxygen demand and the permeability coefficient in the reactive barrier are increased, increased and decreased, respectively, it is determined that the microorganism content in the barrier is greater than the preset microorganism value.

When it is determined that the microorganism content in the reactive barrier is greater than the preset microorganism value, a bacteriostatic agent is injected into the reactive barrier, such that the bacteriostasis treatment is completed.

Optionally, the determining whether the active filler in the reactive barrier is passivated includes:

determining, when redox potential in the reactive barrier exceeds a lower limit of a preset potential range by 10% and a hexavalent chromium concentration downstream of the reactive barrier rises to exceed a preset concentration range, that the active filler in the reactive barrier is passivated, where the preset potential range is −410 mv to −70 mv; and the preset concentration range is 0 mg/L, which reaches 85% of a hexavalent chromium concentration limit in a local groundwater standard; and alternatively,

determining, when a hexavalent chromium concentration downstream of the reactive barrier rises to exceed a preset concentration range, a product gas content in the reactive barrier is kept within a preset range, a permeability coefficient decreases by 30% relative to a standard permeability coefficient, and a pH value changes to exceed an upper limit or a lower limit of a preset PH value range, that the active filler in the reactive barrier is passivated, where the preset concentration range is 0 mg/L, which reaches 85% of a hexavalent chromium concentration limit in a local groundwater standard; and the preset PH value range is 3.0-9.5.

Optionally, the determining whether a gas blockage occurs in the active filler in the reactive barrier includes:

monitoring gas concentrations of hydrogen and methane in the permeable reactive barrier in real time through an embedded gas concentration monitoring probe, and meanwhile, monitoring a barrier permeability coefficient through a permeability coefficient detector; and determining, when the gas concentrations of the hydrogen and the methane dissolved in water reach a high point of a preset range and are kept over 24 h and the barrier permeability coefficient decreases by 30% relative to a standard permeability coefficient, that a gas blockage occurs in the active filler, where a preset hydrogen concentration range is 1 ppb-600 ppb, and a preset methane concentration range is 16 ppb-270 ppb; and due to different mounting positions, the standard permeability coefficient is 750 times a permeability coefficient of soil around the permeable reactive barrier.

Optionally, the determining whether a microorganism content in the reactive barrier is greater than a preset microorganism value includes:

monitoring a gas concentration of methane in the permeable reactive barrier in real time through an embedded gas concentration monitoring probe, meanwhile, monitoring biological oxygen demand and chemical oxygen demand values of a water body in the barrier through embedded biological oxygen demand and chemical oxygen demand probes, meanwhile, monitoring a barrier permeability coefficient through a permeability coefficient detector, and determining, when a methane concentration reaches a high point of a preset range and is kept over 24 h, one of a biological oxygen demand and a chemical oxygen demand reaches a high point of a preset range and is kept over 24 h and the barrier permeability coefficient decreases by 30% relative to a standard permeability coefficient, that the microorganism content in the reactive barrier is greater than the preset microorganism value, where a preset range of the biological oxygen demand is 2 mg/L-10 mg/L, and a preset range of the chemical oxygen demand is 10 mg/L-100 mg/L; and the preset microorganism value is determined through pre-testing according to a field situation due to different mounting positions and different microorganism background values.

The technical solution of the disclosure has the following advantages:

1. The method for preventing and treating pollution plume migration of a permeable reactive barrier according to the disclosure includes the following steps: mounting the monitoring assemblies in the reactive barrier and downstream of the reactive barrier, so as to monitor the operation parameters of the active filler in the reactive barrier and the downstream water body of the reactive barrier in real time; determining whether the active filler in the reactive barrier is passivated according to the change state of the operation parameters, and if passivation occurs, performing a depassivation treatment on the reactive barrier; determining whether a gas blockage occurs in the active filler in the reactive barrier according to the change state of the operation parameters, and if a gas blockage occurs, performing a gas guiding treatment on the reactive barrier; and determining whether the microorganism content in the reactive barrier is greater than the preset microorganism value according to the change state of the operation parameters, and if so, performing a bacteriostasis treatment on the reactive barrier.

The reactive barrier and the downstream water body of the reactive barrier are monitored in real time. The reactive barrier does not need to be excavated in an inspection process, such that the barrier cannot be damaged. Problems during the operation of the reactive barrier may be monitored in real time, and corresponding solutions may be provided in a timely manner. A reactive barrier failure caused by factors such as passivation or inactivation of the active filler, blocking of pores in the active filler by gas, and blocking of pores in the active filler by microorganisms can be accurately avoided, such that the reactive barrier can monitor and deal with the problems in the operation process in a timely manner, the reactive barrier can operate stably for a long time, and the operation life of the reactive barrier can be prolonged.

2. In the method for preventing and treating pollution plume migration of a permeable reactive barrier according to the disclosure, in the operation process of the reactive barrier, if the hexavalent chromium concentration downstream of the reactive barrier rises to exceed the preset concentration range and the product gas content, the permeability coefficient and the pH value in the reactive barrier are unchanged, decreased and increased, respectively, it is determined that the active filler in the reactive barrier is passivated. When it is determined that the active filler in the reactive barrier is passivated, the filler cleaning agent is injected into the reactive barrier until the hexavalent chromium concentration downstream of the reactive barrier is changed to the preset concentration range, such that the depassivation treatment is completed. The monitoring assemblies monitor operation of the reactive barrier in real time. When the active filler in the reactive barrier is treated, the treatment step is controlled according to the monitored operation parameters. When the monitored operation parameters return to a normal level, a treatment process may be completed, and the reactive barrier may be accurately treated. Waste of the filler cleaning agent during treatment is avoided while a treatment effect is ensured, use of chemicals is reduced, and influence caused by excessive penetration of the chemicals into soil and underground water is prevented.

### BRIEF DESCRIPTION OF THE DRAWINGS

In order to more clearly illustrate technical solutions in specific embodiments of the disclosure or in the prior art, the accompanying drawings required for description of the specific embodiments or the prior art will be briefly introduced below. Obviously, the accompanying drawings in the following description are some embodiments of the disclosure, and those of ordinary skill in the art can still derive other drawings from these accompanying drawings without any creative effort.

FIG. 1 is a schematic structural diagram of a permeable reactive barrier with biological filling according to an embodiment of the disclosure.

Description of the reference numbers: 1, one-way breather tube; 2, active filler; 3, circulating gas-guide tube; 4, circulating gas-guide branch tube; 5, isolating cover body.

### DETAILED DESCRIPTION

Technical solutions of the disclosure will be described below clearly and completely in conjunction with the accompanying drawings. Obviously, the described examples are merely some examples rather than all examples of the disclosure. Based on the examples of the disclosure, all the other examples obtained by those of ordinary skill in the art without any creative effort fall within the protection scope of the disclosure.

In the description of the disclosure, it should be noted that the terms “central”, “upper”, “lower”, “left”, “right”, “vertical”, “horizontal”, “inner”, “outer”, etc. indicate azimuthal or positional relations based on those shown in the drawings only for ease of description of the disclosure and for simplicity of description, and are not intended to indicate or imply that the referenced apparatus or element must have a particular orientation and be constructed and operative in a particular orientation, and thus cannot be construed as a limitation on the disclosure. In addition, the terms “first”, “second”, and “third” are only for descriptive purposes, and cannot be interpreted as indicating or implying relative importance.

In the description of the disclosure, it should be noted that unless expressly specified and defined otherwise, the terms “mount”, “connect”, and “connected” are to be construed broadly, which, for instance, can be fixedly connected, or detachably connected, or integrally connected, can be mechanically connected, or electrically connected, or can be directly connected, or indirectly connected by means of an intermediary medium, or communication between interiors of two elements. For those of ordinary skill in the art, specific meanings of the above terms in the disclosure can be understood according to specific circumstances.

Further, technical features involved in different embodiments of the disclosure described below can be combined with one another as long as they do not constitute a conflict with one another.

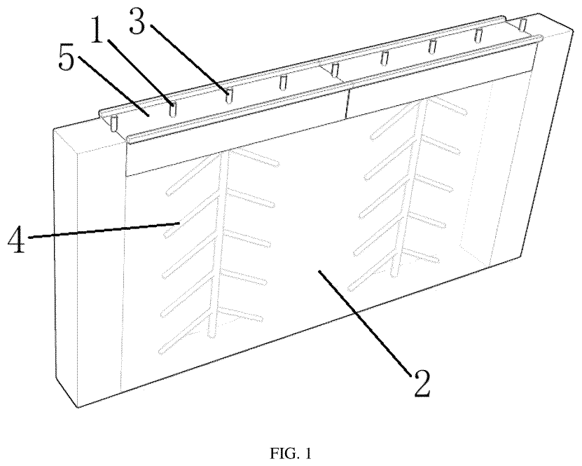

FIG. 1 shows a permeable reactive barrier according to the example. The permeable reactive barrier includes: an accommodating pool, an active filler 2 arranged in the accommodating pool, circulating gas-guide tubes 3, and an isolating cover body 5.

The accommodating pool is filled with the active filler 2. The circulating gas-guide tubes 3 are buried in the active filler 2. A plurality of groups of circulating gas-guide tubes 3 are arranged at intervals in a length direction of the accommodating pool. The isolating cover body 5 is arranged on an upper side of the active filler 2. The circulating gas-guide tubes 3 are arranged to penetrate the isolating cover body 5.

The circulating gas-guide tube 3 is provided with a plurality of circulating gas-guide branch tubes 4 at intervals in an axial direction. The circulating gas-guide branch tubes 4 are in communication with the circulating gas-guide tube 3. The circulating gas-guide branch tubes 4 at a same height are evenly distributed in a circumferential direction of the circulating gas-guide tube 3. A gas-guide branch is arranged obliquely downwards. The isolating cover body 5 is further provided with a one-way breather tube 1. The one-way breather tube 1 extends vertically towards the active filler 2. The one-way breather tube 1 is internally provided with a one-way gas valve or a one-way breathable film, so as to implement one-way breathability. In this way, gas can only flow from inside to outside of the reactive barrier, and air or rain outside the reactive barrier cannot enter the barrier from a one-way breather tube.

In order to improve stability of the reactive barrier during long-term operation and accuracy of pollution prevention and treatment, a cavity of the circulating gas-guide branch tube buried in the active filler 2 is internally provided with a plurality of monitoring assemblies. The monitoring assembly is internally provided with monitoring apparatuses such as a microbial electrode, a temperature sensor, a water level gauge, a flow velocity meter, a potentiometer probe, and a PH composite electrode, such that parameters such as pH, a temperature, an underground water level and flow rate, a redox potential, a resistivity and a permeability coefficient in the active filler 2 are monitored in real time.

A method for preventing and treating pollution plume migration of a permeable reactive barrier according to the example includes the following steps:

monitoring assemblies are mounted in an active filler in a reactive barrier and in underground water upstream and downstream of the reactive barrier, so as to monitor operation parameters of the active filler in the reactive barrier and upstream and downstream water bodies of the reactive barrier in real time. In the example, the monitoring assemblies are mounted in inner cavities of circulating gas-guide branch tubes. In an extension direction of the reactive barrier, all circulating gas-guide tubes 3 are arranged at intervals of 10 m-20 m. A specific interval may be determined according to actual circumstances of soil and underground water in a construction site. A peristaltic pump is mounted on a top of a circulating gas-guide tube in the underground water. The underground water is periodically and quantitatively pumped for detection of some indicators. The permeable reactive barrier is provided with a one-way breather tube and a circulating gas-guide tube. Micro-bubble collectors are arranged in the circulating gas-guide tube. When gas cannot be guided out in a timely manner through the one-way breather tube, an extraction method is used, and the gas is discharged and then liquid is injected back into the active filler of the reactive barrier after gas-liquid separation.

The operation parameters include a hexavalent chromium concentration, a pH value, a temperature, an underground water level and flow rate, a redox potential, a resistivity, a biological oxygen demand, a chemical oxygen demand, a product gas content, and a permeability coefficient. The product gas content is a nitrogen content, a methane content, and a hydrogen content. Through comprehensive analysis of real-time monitoring data, a barrier condition is determined. If a construction condition is not up to standard, quick remedial measures need to be taken. During the operation of the reactive barrier, an operation state of each section of the barrier may be comprehensively determined through real-time monitoring of all the indicators, and the entire or partial barrier may be treated according to specific problems. Signals of the monitoring assemblies may be transmitted to a monitoring and early-warning system in a centralized manner, and monitoring data may be uploaded to an online control platform in real time. If an indicator of a local zone exceeds a set normal range, the system may automatically give an alarm, and the reactive barrier having abnormal indicators may be maintained in sections manually or automatically after authorization.

In an initial operation stage after construction of the reactive barrier is completed, in response to detecting that a permeability coefficient of the reactive barrier in a certain zone is smaller than the preset permeability range, it is determined that more biogum for supporting a side wall of an accommodating pool in a construction process remains in the active filler of the reactive barrier, and the biogum blocks pores of the active filler, which influences permeability of the reactive barrier. In this case, biological enzymes are injected into the reactive barrier through the circulating gas-guide tube, such that a degradation process of the biogum is accelerated, and influence on the permeability coefficient of the reactive barrier is eliminated.

In the initial operation stage after construction of the reactive barrier is completed, if the permeability coefficient of the reactive barrier is greater than the preset permeability range and the hexavalent chromium concentration is greater than the preset concentration range, it is determined that the reactive barrier at a corresponding detection position is defective and water flows directly without being purified by the reactive barrier. In this case, a partition plate is arranged on a defective part, or patches are constructed for repairing.

In a long-term operation process of the reactive barrier:

whether the active filler in the reactive barrier is passivated is determined according to a change state of the operation parameters, and if passivation occurs, a depassivation treatment is performed on the reactive barrier. Specifically, during the operation of the reactive barrier, if the redox potential in the reactive barrier exceeds a preset potential range and the hexavalent chromium concentration downstream of the reactive barrier rises to exceed the preset concentration range, it is determined that the active filler in the reactive barrier is passivated. When it is determined that the active filler in the reactive barrier is passivated, a filler cleaning agent is injected into the reactive barrier through the circulating gas-guide tube until the redox potential is changed to the preset range and the hexavalent chromium concentration downstream of the reactive barrier is changed to the preset concentration range, such that the depassivation treatment is completed. In the operation process of the reactive barrier, if the hexavalent chromium concentration downstream of the reactive barrier rises to exceed the preset concentration range and the product gas content, the permeability coefficient and the pH value in the reactive barrier are unchanged, decreased and increased, respectively, it is determined that the active filler in the reactive barrier is passivated. When it is determined that the active filler in the reactive barrier is passivated, the filler cleaning agent is injected into the reactive barrier through the circulating gas-guide tube until the hexavalent chromium concentration downstream of the reactive barrier is changed to the preset concentration range, such that the depassivation treatment is completed.

The system has two bases for determining whether the reactive barrier is passivated.

1. When the redox potential in the reactive barrier exceeds a lower limit of the preset potential range by 10% and the hexavalent chromium concentration downstream of the reactive barrier rises to exceed the preset concentration range, it is determined that the active filler in the reactive barrier is passivated. The preset potential range is −410 mv to −70 mv. The preset concentration range is 0 mg/L, which reaches 85% of a hexavalent chromium concentration limit in a local groundwater standard. The filler cleaning agent is injected into the reactive barrier through the circulating gas-guide tube until the redox potential changes to an upper limit of the preset potential range, and the hexavalent chromium concentration downstream of the reactive barrier changes to the preset concentration range, such that injection is continued for 2 h, and the depassivation treatment is completed.2. When the hexavalent chromium concentration downstream of the reactive barrier rises to exceed the preset concentration range, the product gas content in the reactive barrier is kept within the preset range, the permeability coefficient decreases by 30% relative to the standard permeability coefficient, and the pH value changes to exceed an upper limit or a lower limit of a preset PH value range, it is determined that the active filler in the reactive barrier is passivated. The preset concentration range is 0 mg/L, which reaches 85% of a hexavalent chromium concentration limit in a local groundwater standard. The preset PH value range is 3.0-9.5. The filler cleaning agent is injected into the reactive barrier through the circulating gas-guide tube until the barrier permeability coefficient reaches the standard permeability coefficient, and the pH changes to the preset range, such that injection is continued for 2 h, and the depassivation treatment is completed.

The system integrates a real-time analysis function. During normal operation, related data are summarized once per day so as to reduce energy consumption. A change curve of the related data is drawn. A passivation risk is determined through internal determination software of the system, and time when passivation occurs is predicted. When it is determined that passivation may occur within 1 month, data summary frequency has to be increased to twice per hour, and operating technicians have to be warned, such that operators may prepare materials or manually conduct depassivation in advance.

Whether a gas blockage occurs in the active filler in the reactive barrier is determined according to the change state of the operation parameters, and if a gas blockage occurs, a gas guiding treatment is performed on the reactive barrier. Specifically, in the operation process of the reactive barrier, if the hexavalent chromium concentration downstream of the reactive barrier rises to exceed the preset concentration range and the product gas content and the permeability coefficient in the reactive barrier are increased and decreased, respectively, it is determined that a gas blockage occurs in the active filler. When it is determined that a gas blockage occurs in the active filler, extraction and gas guiding are performed on the reactive barrier through the circulating gas-guide tube until the hexavalent chromium concentration downstream of the reactive barrier is changed to the preset concentration range and the product gas content and the permeability coefficient in the reactive barrier are decreased and restored to the preset permeability range, respectively, such that the gas guiding treatment is completed.

The gas concentrations of hydrogen and methane in the permeable reactive barrier are monitored in real time through an embedded gas concentration monitoring probe, and meanwhile, the barrier permeability coefficient is monitored through a permeability coefficient detector. When the gas concentrations in water reach a high point of a preset range and are kept over 24 h and the barrier permeability coefficient decreases by 30% relative to the standard permeability coefficient, it is determined that a gas blockage occurs in the active filler. A preset hydrogen concentration range is 1 ppb-600 ppb. A preset methane concentration range is 16 ppb-270 ppb. Due to different mounting positions, the standard permeability coefficient is 750 times a permeability coefficient of soil around the permeable reactive barrier. If extraction and gas guiding operations are conducted, frequency of data summary is increased to 2 times per hour. When the gas concentration reaches a low point of the preset range, the barrier permeability coefficient reaches the standard permeability coefficient and operation power of the circulating gas-guide tube is adjusted to 50%, such that accuracy is improved and energy consumption is reduced. The extraction and gas guiding operations are continued for 6 h, and the extraction and gas guiding operations are stopped. The system is operated dynamically when the permeable barrier operates.

Whether the microorganism content in the reactive barrier is greater than the preset microorganism value is determined according to the change state of the operation parameters, and if so, a bacteriostasis treatment is performed on the reactive barrier. Specifically, in the operation process of the reactive barrier, if the hexavalent chromium concentration downstream of the reactive barrier rises to exceed the preset concentration range and the biological oxygen demand, the chemical oxygen demand and the permeability coefficient in the reactive barrier are increased, increased and decreased, respectively, it is determined that the microorganism content in the barrier is greater than the preset microorganism value. When it is determined that the microorganism content in the reactive barrier is greater than the preset microorganism value, the bacteriostatic agent is injected into the reactive barrier through the circulating gas-guide tube. When the hexavalent chromium concentration downstream of the reactive barrier returns to a normal level, the biological oxygen demand and the chemical oxygen demand in the reactive barrier are decreased to the normal level, and the permeability coefficient is restored, it is proved that the microorganism content is reduced, injection of the bacteriostatic agent is stopped, and the bacteriostasis treatment is completed.

The gas concentration of methane in the permeable reactive barrier is monitored in real time through an embedded gas concentration monitoring probe. Meanwhile, biological oxygen demand and chemical oxygen demand values of the water body in the barrier are monitored through embedded biological oxygen demand and chemical oxygen demand probes. Meanwhile, the barrier permeability coefficient is monitored through a permeability coefficient detector. When a methane concentration reaches a high point of a preset range and is kept over 24 h, one of a biological oxygen demand and a chemical oxygen demand reaches a high point of a preset range and is kept over 24 h and the barrier permeability coefficient decreases by 30% relative to the standard permeability coefficient, it is determined that the microorganism content in the reactive barrier is greater than the preset microorganism value. A preset range of the biological oxygen demand is 2 mg/L-10 mg/L. A preset range of the chemical oxygen demand is 10 mg/L-100 mg/L. The preset microorganism value is determined through pre-testing according to a field situation due to different mounting positions and different microorganism background values. When a biological accumulation blockage occurs, the bacteriostatic agent is injected. In this case, frequency of data summary is increased to 2 times per hour. In the operation, a certain amount of bacteriostatic agent is injected each time, and waiting for 24 h is conducted. If all values are still not up to standard, the quantitative bacteriostatic agent continues to be injected, and so on. When the methane concentration, the biological oxygen demand and the chemical oxygen demand reach a midpoint of the preset range, an injection amount of the bacteriostatic agent is adjusted to 50% of a quantitative amount, such that accuracy is improved and material consumption is reduced. When the methane concentration, the biological oxygen demand and the chemical oxygen demand reach a low point of the preset range and the barrier permeability coefficient reaches the standard permeability coefficient, the injection operation of the bacteriostatic agent is stopped. The system is operated dynamically when the permeable barrier operates.

On the premise of ensuring a treatment effect, operation of the reactive barrier is monitored in real time, and meanwhile, several parts of the reactive barrier are monitored separately, such that the barrier may be repaired in a targeted and accurately-positioned manner during repairing. Treatment cost can be saved by 45% or more by repairing the barrier in sections. A reactive barrier failure caused by factors such as passivation or inactivation of the active filler, blocking of pores in the active filler by gas, and blocking of pores in the active filler by microorganisms can be accurately avoided, such that the reactive barrier can monitor and deal with the problems in the operation process in a timely manner, and the service life of the reactive barrier can be prolonged to 2.5 times of the original life under the operation mode.

Obviously, the above examples are merely instances given for clear illustration, and are not intended to limit the embodiments. Those of ordinary skill in the art can make modifications or variations in other forms on the basis of the above description. There are no need and no way to exhaust all the embodiments. Obvious modifications or variations made thereto shall still fall within the scope of the disclosure.

1. A method for preventing and treating pollution plume migration of a permeable reactive barrier, comprising the following steps:
mounting monitoring assemblies in a reactive barrier and downstream of the reactive barrier, so as to monitor operation parameters of an active filler in the reactive barrier and a downstream water body of the reactive barrier in real time;
determining whether the active filler in the reactive barrier is passivated according to a change state of the operation parameters, and if passivation occurs, performing a depassivation treatment on the reactive barrier;
determining whether a gas blockage occurs in the active filler in the reactive barrier according to the change state of the operation parameters, and if a gas blockage occurs, performing a gas guiding treatment on the reactive barrier; and
determining whether a microorganism content in the reactive barrier is greater than a preset microorganism value according to the change state of the operation parameters, and if so, performing a bacteriostasis treatment on the reactive barrier.

2. The method for preventing and treating pollution plume migration of a permeable reactive barrier according to claim 1, wherein the operation parameters are one or more of a hexavalent chromium concentration, a pH value, a temperature, an underground water level and flow rate, a redox potential, a resistivity, a biological oxygen demand, a chemical oxygen demand, a product gas content, and a permeability coefficient.

3. The method for preventing and treating pollution plume migration of a permeable reactive barrier according to claim 2, wherein the product gas content is a nitrogen content and/or a methane content and/or a hydrogen content.

4. The method for preventing and treating pollution plume migration of a permeable reactive barrier according to claim 1, further comprising: injecting, if the permeability coefficient of the reactive barrier is smaller than a preset permeability range, biological enzymes into the reaction barrier after construction of the reactive barrier is completed.

5. The method for preventing and treating pollution plume migration of a permeable reactive barrier according to claim 1, wherein the method further comprises: determining, if the permeability coefficient of the reactive barrier is greater than a preset permeability range and the hexavalent chromium concentration is greater than a preset concentration range, that the reactive barrier at a corresponding detection position is defective and repairing a defective part after construction of the reactive barrier is completed.

6. The method for preventing and treating pollution plume migration of a permeable reactive barrier according to claim 1, wherein during the operation of the reactive barrier, if the redox potential in the reactive barrier exceeds a preset potential range and the hexavalent chromium concentration downstream of the reactive barrier rises to exceed a preset concentration range, it is determined that the active filler in the reactive barrier is passivated; and
when it is determined that the active filler in the reactive barrier is passivated, a filler cleaning agent is injected into the reactive barrier until the redox potential is changed to a preset range and the hexavalent chromium concentration downstream of the reactive barrier is changed to the preset concentration range, such that the depassivation treatment is completed.

7. The method for preventing and treating pollution plume migration of a permeable reactive barrier according to claim 1, wherein during the operation of the reactive barrier, if the hexavalent chromium concentration downstream of the reactive barrier rises to exceed a preset concentration range and the product gas content, the permeability coefficient and the pH value in the reactive barrier are unchanged, decreased and increased, respectively, it is determined that the active filler in the reactive barrier is passivated; and
when it is determined that the active filler in the reactive barrier is passivated, a filler cleaning agent is injected into the reactive barrier until the hexavalent chromium concentration downstream of the reactive barrier is changed to the preset concentration range, such that the depassivation treatment is completed.

8. The method for preventing and treating pollution plume migration of a permeable reactive barrier according to claim 1, wherein during the operation of the reactive barrier, if the hexavalent chromium concentration downstream of the reactive barrier rises to exceed a preset concentration range and the product gas content and the permeability coefficient in the reactive barrier are increased and decreased, respectively, it is determined that a gas blockage occurs in the active filler; and
when it is determined that a gas blockage occurs in the active filler, extraction and gas guiding are performed on the reactive barrier until the hexavalent chromium concentration downstream of the reactive barrier is changed to the preset concentration range and the product gas content and the permeability coefficient in the reactive barrier are decreased and restored to a preset permeability range, respectively, such that the gas guiding treatment is completed.

9. The method for preventing and treating pollution plume migration of a permeable reactive barrier according to claim 1, wherein during the operation of the reactive barrier, if the hexavalent chromium concentration downstream of the reactive barrier rises to exceed a preset concentration range and the biological oxygen demand, the chemical oxygen demand and the permeability coefficient in the reactive barrier are increased, increased and decreased, respectively, it is determined that the microorganism content in the barrier is greater than the preset microorganism value; and
when it is determined that the microorganism content in the reactive barrier is greater than the preset microorganism value, a bacteriostatic agent is injected into the reactive barrier, such that the bacteriostasis treatment is completed.

10. The method for preventing and treating pollution plume migration of a permeable reactive barrier according to claim 1, wherein the determining whether the active filler in the reactive barrier is passivated comprises:
determining, when redox potential in the reactive barrier exceeds a lower limit of a preset potential range by 10% and a hexavalent chromium concentration downstream of the reactive barrier rises to exceed a preset concentration range, that the active filler in the reactive barrier is passivated; and alternatively,
determining, when a hexavalent chromium concentration downstream of the reactive barrier rises to exceed a preset concentration range, a product gas content in the reactive barrier is kept within a preset range, a permeability coefficient decreases by 30% relative to a standard permeability coefficient, and a pH value changes to exceed an upper limit or a lower limit of a preset PH value range, that the active filler in the reactive barrier is passivated.

11. The method for preventing and treating pollution plume migration of a permeable reactive barrier according to claim 1, wherein the determining whether a gas blockage occurs in the active filler in the reactive barrier comprises:
monitoring gas concentrations of hydrogen and methane in the permeable reactive barrier in real time through an embedded gas concentration monitoring probe, and meanwhile, monitoring a barrier permeability coefficient through a permeability coefficient detector;
and determining, when the gas concentrations of the hydrogen and the methane dissolved in water reach a high point of a preset range and are kept over 24 h and the barrier permeability coefficient decreases by 30% relative to a standard permeability coefficient, that a gas blockage occurs in the active filler.

12. The method for preventing and treating pollution plume migration of a permeable reactive barrier according to claim 1, wherein the determining whether a microorganism content in the reactive barrier is greater than a preset microorganism value comprises:
monitoring a gas concentration of methane in the permeable reactive barrier in real time through an embedded gas concentration monitoring probe, meanwhile, monitoring biological oxygen demand and chemical oxygen demand values of a water body in the barrier through embedded biological oxygen demand and chemical oxygen demand probes, meanwhile, monitoring a barrier permeability coefficient through a permeability coefficient detector, and determining, when a methane concentration reaches a high point of a preset range and is kept over 24 h, one of a biological oxygen demand and a chemical oxygen demand reaches a high point of a preset range and is kept over 24 h and the barrier permeability coefficient decreases by 30% relative to a standard permeability coefficient, that the microorganism content in the reactive barrier is greater than the preset microorganism value.

13. The method for preventing and treating pollution plume migration of a permeable reactive barrier according to claim 2, further comprising: injecting, if the permeability coefficient of the reactive barrier is smaller than a preset permeability range, biological enzymes into the reaction barrier after construction of the reactive barrier is completed.

14. The method for preventing and treating pollution plume migration of a permeable reactive barrier according to claim 3, further comprising: injecting, if the permeability coefficient of the reactive barrier is smaller than a preset permeability range, biological enzymes into the reaction barrier after construction of the reactive barrier is completed.

15. The method for preventing and treating pollution plume migration of a permeable reactive barrier according to claim 2, wherein the method further comprises: determining, if the permeability coefficient of the reactive barrier is greater than a preset permeability range and the hexavalent chromium concentration is greater than a preset concentration range, that the reactive barrier at a corresponding detection position is defective and repairing a defective part after construction of the reactive barrier is completed.

16. The method for preventing and treating pollution plume migration of a permeable reactive barrier according to claim 3, wherein the method further comprises: determining, if the permeability coefficient of the reactive barrier is greater than a preset permeability range and the hexavalent chromium concentration is greater than a preset concentration range, that the reactive barrier at a corresponding detection position is defective and repairing a defective part after construction of the reactive barrier is completed.

17. The method for preventing and treating pollution plume migration of a permeable reactive barrier according to claim 2, wherein during the operation of the reactive barrier, if the redox potential in the reactive barrier exceeds a preset potential range and the hexavalent chromium concentration downstream of the reactive barrier rises to exceed a preset concentration range, it is determined that the active filler in the reactive barrier is passivated; and
when it is determined that the active filler in the reactive barrier is passivated, a filler cleaning agent is injected into the reactive barrier until the redox potential is changed to a preset range and the hexavalent chromium concentration downstream of the reactive barrier is changed to the preset concentration range, such that the depassivation treatment is completed.

18. The method for preventing and treating pollution plume migration of a permeable reactive barrier according to claim 3, wherein during the operation of the reactive barrier, if the redox potential in the reactive barrier exceeds a preset potential range and the hexavalent chromium concentration downstream of the reactive barrier rises to exceed a preset concentration range, it is determined that the active filler in the reactive barrier is passivated; and
when it is determined that the active filler in the reactive barrier is passivated, a filler cleaning agent is injected into the reactive barrier until the redox potential is changed to a preset range and the hexavalent chromium concentration downstream of the reactive barrier is changed to the preset concentration range, such that the depassivation treatment is completed.

19. The method for preventing and treating pollution plume migration of a permeable reactive barrier according to claim 2, wherein during the operation of the reactive barrier, if the hexavalent chromium concentration downstream of the reactive barrier rises to exceed a preset concentration range and the product gas content, the permeability coefficient and the pH value in the reactive barrier are unchanged, decreased and increased, respectively, it is determined that the active filler in the reactive barrier is passivated; and
when it is determined that the active filler in the reactive barrier is passivated, a filler cleaning agent is injected into the reactive barrier until the hexavalent chromium concentration downstream of the reactive barrier is changed to the preset concentration range, such that the depassivation treatment is completed.

20. The method for preventing and treating pollution plume migration of a permeable reactive barrier according to claim 3, wherein during the operation of the reactive barrier, if the hexavalent chromium concentration downstream of the reactive barrier rises to exceed a preset concentration range and the product gas content, the permeability coefficient and the pH value in the reactive barrier are unchanged, decreased and increased, respectively, it is determined that the active filler in the reactive barrier is passivated; and
when it is determined that the active filler in the reactive barrier is passivated, a filler cleaning agent is injected into the reactive barrier until the hexavalent chromium concentration downstream of the reactive barrier is changed to the preset concentration range, such that the depassivation treatment is completed.
